(19) United States
(12) Patent Application Publication
(10) Pub. No.: US 2024/0281816 A1
(43) Pub. Date: Aug. 22, 2024

(54) SYSTEMS AND METHODS FOR ANOMALY PREDICTION

(71) Applicant: STRIPE, INC., South San Francisco, CA (US)

(72) Inventors: Meidan Bu, Bellevue, WA (US); Ramy Shoker, Seattle, WA (US); Adam Behrens, Medron, MA (US)

(21) Appl. No.: 18/112,215

(22) Filed: Feb. 21, 2023

(51) Int. Cl. G06Q 20/40; G06N 20/00; G06Q 20/38

(52) U.S. Cl. CPC G06Q 20/4016; G06N 20/00; G06Q 20/389

(57) ABSTRACT

Systems and methods for anomaly prediction are disclosed. An anomaly detection system identifies data generated for a customer. A first set of features for the customer are identified based on the data. The system performs an anomaly evaluation based on detecting a criterion. The anomaly evaluation may include identifying a customer segment based on the first set of features; identifying a distribution of values for the customer segment; determining, based on the distribution of values, whether a value associated with the first set of features satisfies a threshold; and in response to the determining that the value satisfies the threshold, invoking a machine learning model for predicting an anomaly for the customer based on at least a portion of the data. A notification may be transmitted about the anomaly to trigger an action for addressing the anomaly.

### BACKGROUND

Accurate billing of customers is important not only for a successful business, but for ensuring customer trust. If the customer does not understand why and how they are billed, the customer may not engage the business for future services. The use of different payment or billing structures for different types of customers, however, can lead to billing mistakes.

The above information disclosed in this Background section is only for enhancement of understanding of the background of the present disclosure, and therefore, it may contain information that does not form prior art.

### SUMMARY

In one or more embodiments, the present disclosure is directed to systems and methods for detecting billing anomalies, substantially as shown in and/or described in connection with at least one of the figures, as set forth more completely in the claims. Of course, the actual scope of the invention is defined by the appended claims.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 depicts a computing environment for detecting billing anomalies according to one or more embodiments;

FIG. 2 depicts a block diagram of an anomaly detection system according to one or more embodiments;

FIG. 3 depicts a flow diagram of a process for generating customer segments according to one or more embodiments;

FIG. 4A depicts an example of unstructured pricing data stored for a particular customer in a data storage device according to one or more embodiments;

FIG. 4B depicts example pricing data that has been transformed into a structured format according to one or more embodiments;

FIG. 5 depicts a process flow for training a supervised system for making anomaly predictions according to one or more embodiments;

FIG. 6 depicts a process flow diagram of a process for predicting billing anomalies according to one or more embodiments; and

FIG. 7 depicts a graphical user interface (GUI) provided by an anomaly detection system according to one or more embodiments.

### DETAILED DESCRIPTION

Hereinafter, example embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated. Further, in the drawings, the relative sizes of elements, layers, and regions may be exaggerated and/or simplified for clarity.

A business may employ different pricing, billing, or fee structures (collectively referred to as pricing data) for different types of customers. The pricing data for a product or service to be provided by the business to the customer may be set based on negotiated terms of a contract between the customer and the business. For example, if the service provided by the business is the processing of credit card payments, a fixed rate may be charged for each credit card transaction for one customer, but a variable rate may be charged for another customer that may depend, for example, on a total number of transactions or total payment volume processed for the customer. The pricing data for the first customer may thus indicate the fixed rate, and the pricing data for the second customer may indicate the variable rate.

Humans may be employed to enter the pricing data for a customer into the business' billing system. Humans are prone to errors. Mistakes may be made by a person entering the negotiated pricing data into the billing system. The errors may lead to underbilling or overbilling (collectively referred to as “anomalies” or “billing anomalies”) for the customer. The errors may not only create loss of revenue for the business, but also customer dissatisfaction.

It may be desirable, therefore, to survey customer pricing data from time to time to identify billing anomalies. Manually auditing the pricing data for hundreds, if not thousands of customers, may be an impractical solution, especially when there are numerous different combinations of pricing possibilities that may be used for a particular customer.

One or more embodiments of the present disclosure are directed to systems and methods for predicting billing anomalies due to anomalies in customers' pricing data. In some embodiments, an anomaly detection system utilizes a layered or sequential architecture to predict the billing and/or pricing anomalies (collectively referenced as billing anomalies). For example, a first filtering layer of the architecture may identify apparent pricing errors using an outlier detection method. In this regard, the anomaly detection system may group the customer into a customer segment based on a set of features. The customer's pricing data may be evaluated against a statistical distribution of historical pricing data for other customers in the customer segment.

In some embodiments, the customer's pricing data is preprocessed for converting the pricing data from an unstructured non-relational format, to a structured tabular or relational format. The converted customer's pricing data may be evaluated against one or more of the statistical distributions to which the customer belongs. A determination may be made as to whether the customer's pricing data differs significantly from prior observations of the customers in the customer segment, and is thus, an outlier. If the customer's pricing data is deemed an outlier, it may be flagged as anomalous.

The pricing data for the particular customer may have less apparent anomalies that may not be immediately flagged as anomalous by the first filtering layer. In some embodiments, pricing data that is not flagged as anomalous by the first filtering layer is further evaluated by a second machine learning layer. The machine learning layer may include an unsupervised system and/or a supervised system. The unsupervised system may include an unsupervised machine learning model configured to classify the input pricing data as similar or different from a normal (non-anomalous) pricing data learned by the model.

In some embodiments, a human auditor may be prompted to validate a prediction by the unsupervised system that the input pricing data is anomalous. If the prediction is valid, the human auditor may generate a label (e.g., an “anomalous” label) for the input pricing data. The labeled data may be used for training a supervised machine learning model in the supervised system.

In some embodiments, the supervised system may be invoked in addition or in lieu of the unsupervised machine learning model for making anomaly predictions of the particular customer's pricing data. The supervised machine learning model may be, for example, a binary classifier configured to determine whether or not input pricing data is anomalous or not.

In some embodiments, a remediation system may be invoked for taking remediation actions for pricing data that is flagged as anomalous. The remediation action may include, for example, transmitting a notification to a billing administrator of the anomaly. The remediation action may further include recommending appropriate pricing data for the customer based on, for example, characteristics of similar customers.

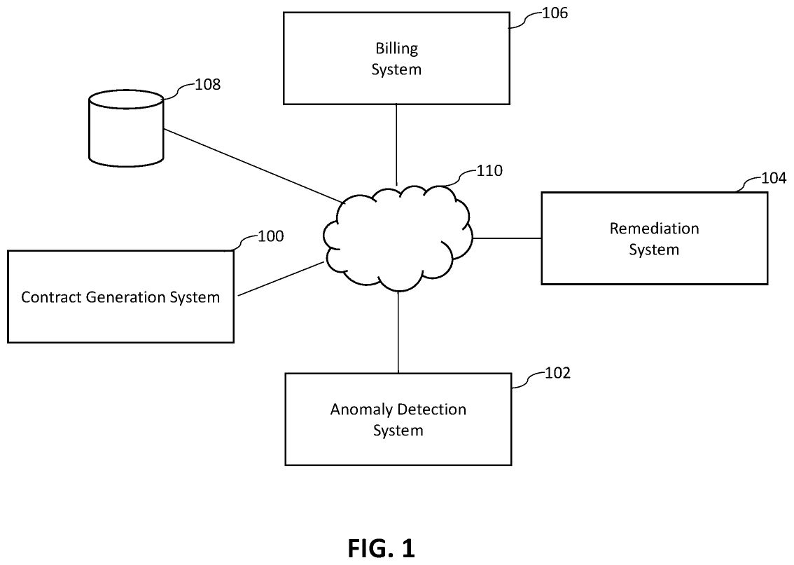

FIG. 1 depicts a computing environment for detecting billing anomalies according to one or more embodiments. The computing environment includes a contract generation system 100, anomaly detection system 102, remediation system 104, billing system 106, and data storage device 108, that are coupled to one another over a data communications network 110. The data communications network 108 may be any wired or wireless local area network (LAN), private wide area network (WAN), and/or the public Internet. The various systems 100-106 may include one or more servers or computing devices. The servers and/or computing devices may include a processor and memory. The memory may include instructions that, when executed by the processor, cause the processor to provide the functionality described with respect to the corresponding system 100-106.

In some embodiments, the contract generation system 100 is configured with tools (e.g., a graphical user interface, webpage, etc.) for generating a contract for a customer desiring to purchase goods or services (hereinafter referred to as “products”) of a business. The terms of the contract may include, for example pricing data. The pricing data may determine how the business is to charge the customer for the products provided by the business. The pricing data may be customized for the customer, or be based on pricing data used for other customers similar to the customer. In some embodiments, the pricing data includes a default currency, type of rate (e.g., fixed or variable), values associated with the type of rate, and/or the like.

The billing system 106 may be configured with tools to generate invoices for the customer based on the negotiated pricing data. In this regard, the billing system includes a graphical user interface that may prompt a human administrator to input the pricing data from the negotiated contract. The entered pricing data may be stored, for example, in the data storage device 108 in association with the customer.

Because humans are prone to errors, mistakes may be made in entering the pricing data into the billing system 106. Errors may also occur when importing the pricing data into the billing system 106 from another system. For example, an incorrect pricing structure may be entered for the customer, or although the entered pricing structure may be correct, it may be incorrect for the particular customer.

The billing system 106 may be configured to detect usage events (e.g., use of the business' services), and generate invoices based on the usage events. For example, invoices may be generated on a monthly basis based on usage of the business' services for the month. The invoices may be generated based on the pricing data stored for the customer. The generated invoices may be stored in the data storage device 108 in association with the customer.

The anomaly detection system 102 may be configured to predict billing anomalies based on anomalies in the customer's pricing data. In some embodiments, the anomaly detection occurs periodically as a batch process based on billing invoices generated by the billing system 106 and stored in the data storage device 108. In some embodiments, anomaly detection is invoked for a new customer during (or immediately after) onboarding the customer into the billing system 106, prior to generating of a first invoice, to help prevent billing anomalies from occurring in the first place.

In some embodiments, the anomaly detection system 102 uses a layered or sequential architecture to identify the billing anomalies. In this regard, a first filtering layer of the anomaly detection system 102 may detect apparent anomalies in the pricing data for a customer. The detecting of apparent anomalies may entail clustering the customer into a customer segment based on a set of customer features. One or more probabilistic distributions may be generated for each of the customer segments. The probabilistic distribution of the customer segment to which the customer is clustered may be used to determine whether the customer's pricing data is an outlier that is to be flagged as anomalous.

A second machine learning layer of the anomaly detection system 102 may predict billing anomalies caused by less apparent errors in the pricing data that may not be caught by the first filtering layer. The second machine learning layer may include one or more machine learning models. The one or more machine learning models may be trained to predict billing anomalies based on input features. The input features may include one or more customer features (e.g., customer type, customer size, customer tenure, etc.) and/or billing features (e.g., total transactions, total payment volume, total revenue, rate type, etc.).

In some embodiments, the anomaly detection system 102 may be configured with tools for auditing the predictions made by one or more of the machine learning models. The pricing data that is accurately predicted to be anomalous may be labeled. The labeled data may be added to a training dataset used to train and/or retrain one or more of the machine learning models.

The remediation system 104 may receive information on pricing data that is flagged to be anomalous. The remediation system 104 may take one or more actions for addressing the anomaly. The one or more actions may include, for example, transmitting a notification about the anomaly (e.g., to the billing system 106). The notification may prompt a human auditor to review the flagged billing invoices. If the invoices are verified to be anomalous, the billing system 106 may correct the pricing data and generate updated invoices based on the corrected pricing data. The billing system 106 (or the remediation system 104) may contact the customers associated with the billing anomaly, and transmit the updated invoices to the customers.

In some embodiments, the remediation system 104 is configured to make a recommendation for addressing the anomaly. The recommendation may include, for example, timing and mode of contact of the customer for notifying the customer of the anomaly. The recommendation may also include a correction for the anomalous pricing data. For example, the remediation system 104 may identify an erroneous portion of the pricing data and recommend a correction based on, for example, pricing data of other similar customers. The other similar customers may be customers in a same customer segment.

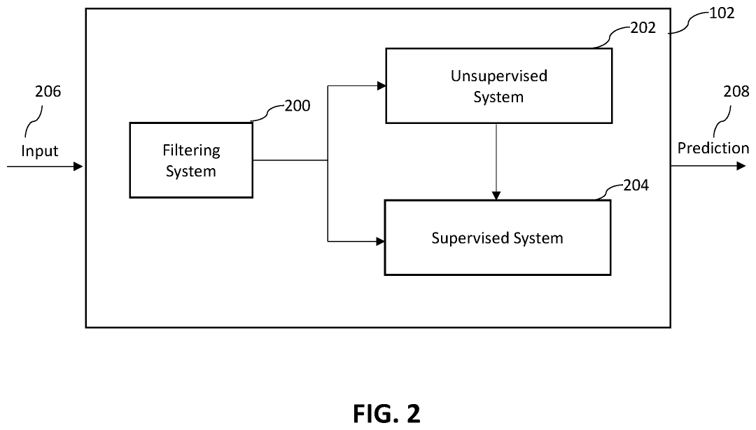

FIG. 2 depicts a block diagram of the anomaly detection system 102 according to one or more embodiments. The anomaly detection system 102 may include a filtering system 200, an unsupervised system 202, and a supervised system 204. Although the filtering system 200, unsupervised system 202, and supervised system 204 are depicted as separate systems, a person of skill in the art should recognize that these systems 200-204 may be combined into a single system, or one or more of the systems may be further subdivided into additional sub-systems as will be appreciated by a person of skill in the art.

In some embodiments, the anomaly detection system 102 receives, as input 206, billing invoice data for a particular customer for which a billing anomaly is to be determined. In some embodiments, the received input 206 is a batch input consisting of billing invoice data that has been accumulated for a period of time. The billing invoice data may allow the identification of customer features and customer pricing data used for generating the billing invoices.

One or more of the filtering system 200, unsupervised system 202, or supervised system 204 may process the input 206 for generating a billing anomaly prediction 208 that indicates whether the billing invoices (and hence, the associated pricing data) is anomalous. The anomaly detection system 102 may employ a layered approach for generating the prediction.

In some embodiments, the filtering system 200 implements a first layer of the architecture for billing anomaly detection. In this regard, the filtering system 200 may process the input 206 to identify a set of features for the particular customer. The identified set of features may include, without limitation, customer size, product type, number of transactions, total payment value, total revenue, customer tenure, and/or the like.

The filtering system 200 may identify a customer segment based on the identified set of features. The identified customer segment may include other customers with features similar to the identified features of the particular customer.

In some embodiments, the filtering system 200 evaluates the pricing data of the customer used to generate the billing invoices to determine whether the pricing data has apparent anomalies. The pricing data may include, for example, key-value pairs corresponding to pricing parameters associated with the particular customer.

In some embodiments, the filtering system 200 analyzes one or more of the key-value pairs in the customer's pricing data for identifying outlier values. An outlier value may be determined based on a probabilistic distribution generated based on pricing data of other customers in the customer segment. The filtering system 200 may flag the input 206 as anomalous in response to identifying an outlier value.

In some embodiments, the filtering system 200 generates the customer segments that are used in the first layer of the architecture for billing anomaly detection. The customer segments may be generated based on one or more customer features. For example, customers may be clustered into customer segments based on similarities in payment volume and/or revenue. In this regard, customers that fall into a first range of the payment volume and/or revenue may be grouped in a first customer segment, and customers that fall into a second range of the payment volume and/or revenue may be grouped in a second customer segment.

In some embodiments, the filtering system 200 automatically selects a total number of customer segments, and generates the customer segments according to the automatically selected number. For example, the total number of customer segments may be automatically selected by scaling the input data and optimizing a cluster inertia using a method such as, for example, an “elbow” method. A clustering algorithm such as, for example, a K-Means clustering algorithm may be used to generate the selected number of customer segments.

In some embodiments, the filtering system 200 determines a distribution of values (e.g., probabilistic distribution) for each customer segment based on the billing invoices and associated pricing data of the customers that belong to the cluster. In some embodiments, the distribution is calculated based on one or more pricing parameters. An example pricing parameter for which a distribution may be generated may be a type of rate (e.g. a variable rate), and the probabilistic distribution may include values of the variable rate associated with the customers in the customer segment.

In some embodiments, an outlier threshold is calculated for a probabilistic distribution generated for a customer segment. The outlier threshold may be used for determining outlier values for the distribution. In some embodiments, the outlier threshold is calculated according to the following formula, although embodiments are not limited thereto:

Lower Outlier Threshold=25^{th} percentile−1.5*IQR(N)

Upper Outlier Threshold=75^{th} percentile+1.5*IQR(N)

where IQR is the interquartile range IQR of distribution N.

The filtering system 200 may determine that a value of a pricing parameter is anomalous if the value is outside of the outlier threshold of the corresponding distribution.

In some embodiments, the pricing data used to generate the distributions are stored in the data storage device 108 in an unstructured non-relational format. For example, the pricing data may be stored as a list that contains recursively nested pricing parameters (also referred to as predicates). Each pricing parameter may be represented using a key-value pair.

In some embodiments, the filtering system 200 is configured to process the unstructured pricing data into structured pricing data. The structured data may be, for example, a table with structured rows and columns. Each of the columns may be associated with a key (e.g., a pricing parameter), and the rows may store specific values for the key. The conversion of the unstructured pricing data into the structured data may allow the filtering system 200 to use the pricing data for generating the probabilistic distributions for the clusters.

In some embodiments, pricing data anomalies that are not apparent outliers may nonetheless be detected via one or more machine learning models in a second layer of the architecture for billing anomaly detection. In this regard, the unsupervised system 202 and the supervised system 204 may each include one or more machine learning models that have been trained to predict billing anomalies based on one or more machine learning algorithms.

The machine learning model for the unsupervised system may be a support vector machine (SVM), autoencoder, and/or the like. For example, if an SVM is used, the SVM may be a one class SVM to generate a certain percentage of anomalous points based on a soft boundary. In making a prediction, the SVM may process the input 206 to determine whether the input is within or outside of the computed border. If the input data is outside of the border, it may be flagged as an anomaly.

In another example, if an autoencoder is used, the autoencoder may learn to represent the pricing data of billed customers without anomalies, in a compressed manner. In determining whether the input data 206 should be flagged as an anomaly, the autoencoder may determine the loss resulting in the reconstruction of the compressed version of the input 206. An anomaly may be flagged if the loss is greater than a threshold amount.

In some embodiments, the unsupervised system 202 may signal the billing system 105 to analyze the predictions made by the unsupervised system 202. The billing system 105 may provide tools for a human auditor to view the billing invoices and pricing data for the particular customer. The pricing data that is stored in the billing system 105 may be compared against the pricing data negotiated for the customer (e.g., the pricing data that appears in the contract with the customer). The billing system 105 may transmit results of the comparison to the unsupervised system 202. In some embodiments, if the anomaly prediction is correct, the unsupervised system 202 may generate a label (e.g., an “anomalous” label) for the input 206. The labeled input may be added to a training dataset.

In some embodiments, the supervised system 204 includes one or more machine learning models that have been trained using the labeled training data in the training dataset. The machine learning model for the supervised system 204 may be a Bayesian classifier, gradient boosted trees, and/or the like. The supervised system may learn from the labeled training data to identify normal pricing data and anomalous pricing data. In this regard, the supervised system may associate features of the input 206 (e.g., customer features and/or billing features), to the learned features, and identify a label for the input as normal or anomalous based on the label of the learned features to which the input features may be associated.

In some embodiments, whether the unsupervised system 202 or the supervised system 204 is invoked to make predictions may depend on whether there is sufficient labeled training data in the training dataset to train the supervised system 204. The supervised system 204 may be trained based on available training data until a threshold level of accuracy is achieved in the predictions made by the supervised system 204. The system may transition from using the unsupervised system 202 to the supervised system 204 in response to the supervised system 204 reaching the threshold level of accuracy.

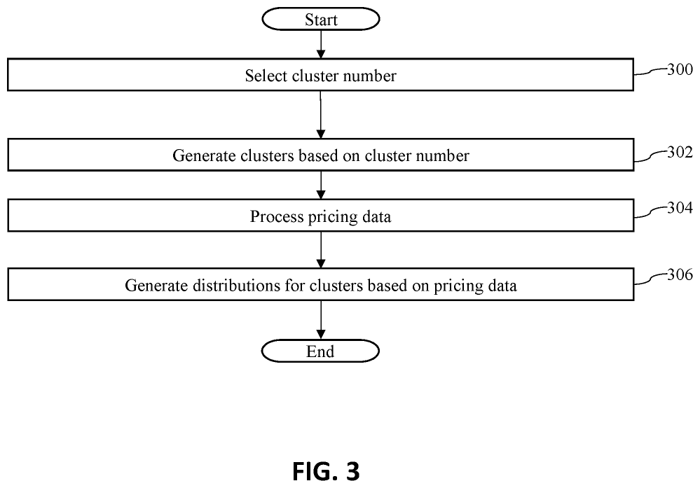

FIG. 3 depicts a flow diagram of a process for generating customer segments according to one or more embodiments. The process starts, and in act 300, a cluster number is automatically selected by, for example, the filtering system 200. The cluster number may be selected based on the “elbow” method.

In act 302, clusters corresponding to the customer segments are generated based on the cluster number. The customer segments may be generated based on one or more customer features such as, for example, total payment volume and/or revenue. Total payment volume and/or revenue may be calculated based on historical billing data for the customers of the business. For example, if the automatically selected number in act 300 is “5,” act 302 generates five different clusters for grouping existing customers into one of the five customer segments.

In act 304, pricing data for existing customers is processed for generating one or more distributions for a customer segment. In this regard, pricing data for a customer may be stored in the data storage device 108 in an unstructured, non-relational format. For example, the pricing data may be stored as nested key-value pairs that is inaccessible in a relational format.

In some embodiments processing of the pricing data includes converting the unstructured pricing data into structured pricing data. In this regard, an algorithm such as a depth-first search algorithm may be used to disaggregate the pricing data into respective key-value pairs that represent a pricing parameter. The output of the processing of the data may be the pricing data for one or more customers, represented in a structured format (e.g., a table).

In act 306, distributions are generated for the customer segments based on the structured pricing data. The distributions may be generated based one or more pricing parameters. For example, distributions may be generated for fixed and/or variable rates for a particular type of product. In some embodiments, statistical outliers of each distribution may be calculated based on, for example, the IQR of the distribution, although embodiments are not limited thereto. For example, outliers may also be detected by measuring three standard deviations from the mean.

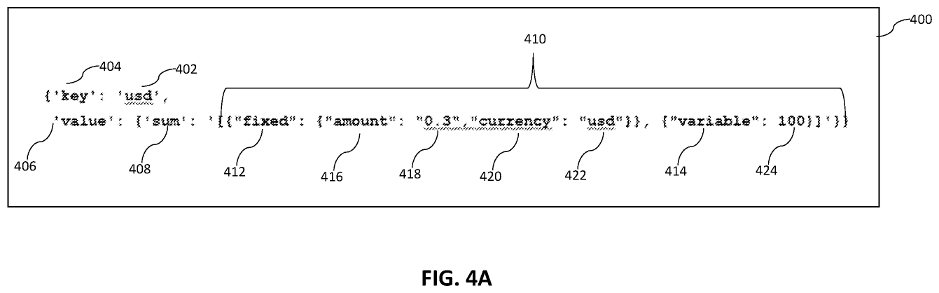

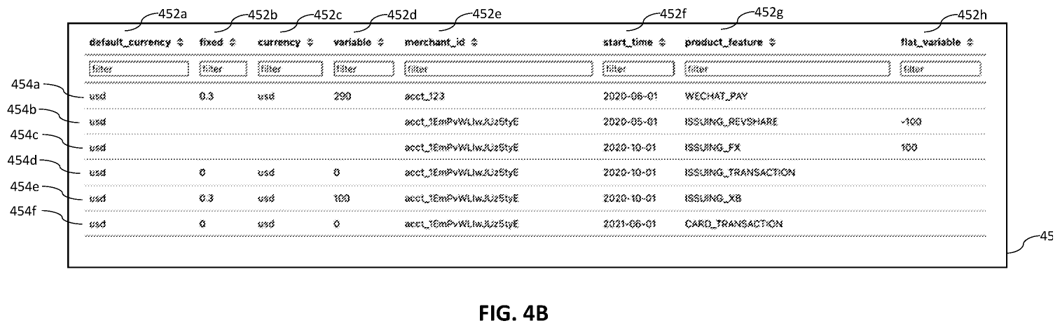

FIG. 4A depicts an example of unstructured pricing data 400 stored for a particular customer in the data storage device 108 according to one or more embodiments. The pricing data may be stored using a JavaScript Object Notation (JSON) format. In some embodiments, the pricing data is represented as an array of nested JSONs.

In the example of FIG. 4A, a default currency (e.g., “USD” 402) may be associated with a “key” 404. The value of the “key” 404 may identify a particular pricing model. The pricing structure of the particular pricing model may be associated with a “value” key 406. In the example of FIG. 4A, the “value” key 406 is associated with a “sum” 408 pricing structure which may be represented via an array of nested JSONs 410 defining additional key-value pairs. The value of the “sum” 408 pricing structure may be a “fixed” 412 rate and a “variable” 414 rate. The “fixed” 412 rate may be associated with a fixed “amount” 416 to be charged per transaction (e.g., 30 cents 418), and a “currency” 420 associated with the fixed amount (e.g., “USD” 422). The “variable” 414 rate may be associated with a variable rate value 424 (e.g., 100) to be added to the fixed rate.

FIG. 4B depicts example pricing data that has been transformed into a structured format according to one or more embodiments. The structured format in the example of FIG. 4B is a table 450 having one or more columns 452a-452h (collectively referenced as 452). The columns 452 may be represent different pricing parameters (e.g., type of currency, type of rate, merchant information, product information, and/or the like). One or more of the pricing parameters may be retrieved, for example, by deconstructing the unstructured pricing data stored for one or more customers.

Each row 454a-454f (collectively 454) of the table may represent a deconstructed pricing data for a particular customer. For example, the unstructured pricing data in the example of FIG. 4A may be stored in a structured format in row 454e. In this regard, the filtering system 200 may perform a depth first search of the array of nested JSONs 410 to retrieve the variable rate value 424 for the “variable” 414 key from the nested JSON, an amount of 30 cents 418 for an “amount” key, and a “USD” 422 currency for the “currency” 420 key, from the nested JSON. The retrieved amount of 30 cents 418 may further be associated with the “fixed” key in the nested JSON. The retrieved values may respectively be stored in a “variable” column 452d, a “currency” column 452c, and a “fixed” column 452b for the table 450. A person of skill in the art should understand that as the complexity and nesting of the unstructured data increases for the hundreds if not thousands of customers who may have different, customized pricing structures, manual decomposition of the data into the structured format may not be practical. The automating the conversion of the unstructured data into a structured format allows historical pricing data to be useable for automating the detection of pricing anomalies.

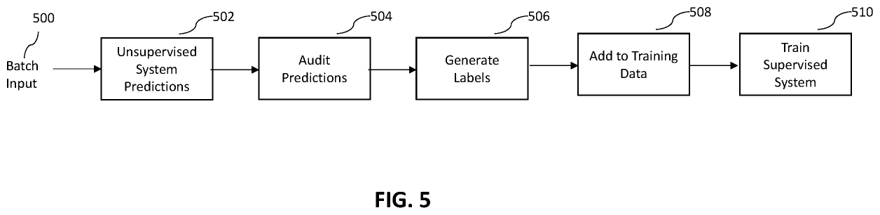

FIG. 5 depicts a process flow for training the supervised system 204 for making anomaly predictions according to one or more embodiments. In act 202, the unsupervised system 202 receives an input, such as, for example, a batch input 500 of billing invoice data stored in the data storage device 108. For example, the batch input 500 may correspond to billing invoices of various customers collected for a period of time.

In act 502, the unsupervised system 202 predicts whether the billing data in the input batch 500 is anomalous or not. The prediction may be based on training received by the unsupervised system 202. For example, the unsupervised system 202 may predict that the billing data is anomalous if the billing data is outside of a learned boundary for normal pricing data.

In act 504, one or more of the predictions made by the unsupervised system 202 may be transmitted to the billing system 106 for auditing. In this this regard, the unsupervised system 202 may transmit a message for prompting a human auditor to verify accuracy of the one or more predictions, and generate labels, in act 506, for the one or more predictions deemed to be accurate.

In one embodiment, the billing system 106 provides tools, (e.g., a graphical user interface) accessible to the human auditor for viewing the billing data and comparing the billing data against the pricing data negotiated for the customer. The billing system 106 further provides tools for adding a label (e.g., an “anomalous” label) to the billing data verified to be anomalous. The labeled billing data may be stored in a training dataset.

In act 520, the supervised system 204 is invoked for training a machine learning model using the training dataset. The training of the machine learning model may be based on a criterion. For example, the criterion may be detected if the amount of training data labeled as “anomalous” reaches a particular threshold. For example, the training may be invoked when the amount of anomalous training data substantially equals an amount of normal data. In some embodiments, once the supervised system 204 is trained, billing anomaly predictions may be performed by the supervised system instead of the unsupervised system 202. In some embodiments, both the supervised system 204 and the unsupervised system 202 are invoked for performing the predictions.

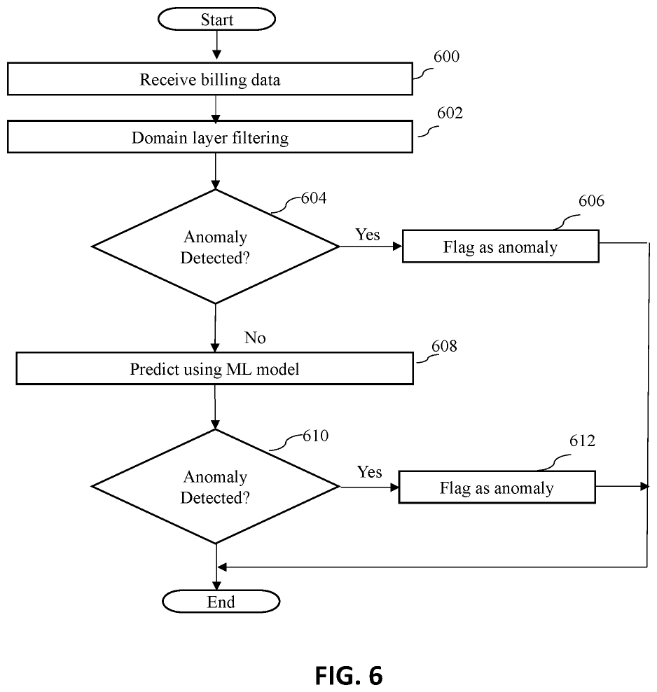

FIG. 6 depicts a process flow diagram of a process for predicting billing anomalies for a customer whose invoice(s) have not yet been evaluated by the anomaly detection system 102 according to one or more embodiments. The process starts, and in act 600, the anomaly detection system 102 identifies billing data generated for the customer. The billing data may be used to identify a set of features (e.g., a first set of features) associated with the customer. The first set of features may include, for example, a total payment value, total revenue, customer size, and/or customer tenure. The features may be obtained by processing the billing data. For example, the billing data may identify a merchant identifier (ID) that may be used to retrieve the customer's profile such as, for example, the customer size, customer tenure, and/or the like. The merchant ID may also be used to retrieve the customer's pricing data if not already included as part of the billing data. In some embodiments, the retrieved customer's pricing data is unstructured data that may be processed into a structured format that identifies values for corresponding pricing parameters.

In act 602, at least a portion of the billing data is used by the filtering system 200 for identifying a customer segment to which the customer belongs. The identification of the customer segment may be based on calculating a distance to each of the cluster centers using the values of the portion of the billing data. The customer segment with a minimum distance to a cluster center may be identified as the customer segment to which the customer belongs.

In act 604, the filtering system 200 determines whether a billing anomaly may be detected based on one or more distributions associated with one or more pricing parameters for the selected customer segment. In this regard, the filtering system 200 identifies the one or more probabilistic distributions of values for the customer segment, and determines, based on the distribution of the values, whether a value of a pricing parameter in the billing data satisfies a threshold. The threshold may be an outlier threshold calculated for the probabilistic distribution. An anomaly may be detected if the value of the pricing parameter in the billing data is outside of the outlier threshold.

If a billing anomaly is detected, the billing data is flagged as an anomaly in act 606.

Referring again to act 604, if the values of one or more pricing parameters in the billing data are within the outlier threshold (satisfy the outlier threshold), the unsupervised system 202 and/or the supervised system 204 is invoked, in act 608, for further attempts at anomaly prediction. In this regard, an unsupervised machine learning model and/or a supervised machine learning model is invoked for making an anomaly prediction based on the billing data.

In act 610, a determination is made as to whether an anomaly is detected based on the machine learning model(s). If the answer is YES, the billing data is flagged as an anomaly in act 612.

In some embodiments, a notification is transmitted to the remediation system 104 in response to predicting an anomaly. The notification may trigger an action for addressing the anomaly. The action may be, for example, for the remediation system 104 to generate and transmit a message to the customer informing the customer of the billing anomaly. In some embodiments, the remediation system 104 may correct the pricing data for the customer and generate a corrected billing invoice based on the corrected pricing data.

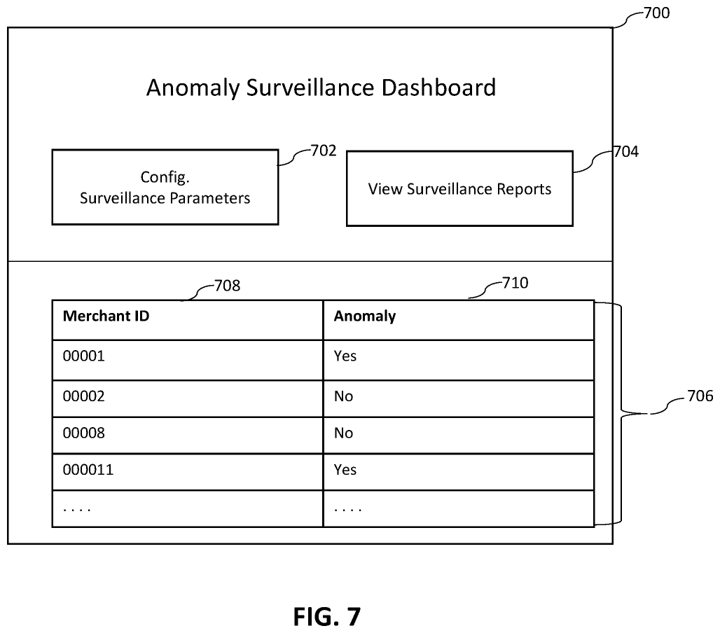

FIG. 7 depicts a graphical user interface (GUI) 700 provided by the anomaly detection system 102 according to one or more embodiments. The GUI may be accessed by a system administrator for configuring anomaly surveillance and for viewing reports generated as a result of the anomaly surveillance according to one or more embodiments.

The GUI 700 may include a configuration option 702 for configuring one or more surveillance parameters of the anomaly detection system 102. The surveillance parameters may relate, for example, to the timing and/or type of billing invoices to be checked for billing anomalies. For example, billing invoices generated for a particular period of time (e.g., a month) may be surveyed at the end of the time period.

In some embodiments, the billing invoices that are surveyed may be identified based on one or more criteria. For example, the survey may be limited to invoices that have been generated for the first time for a customer. Once the pricing data for the customer is identified as normal, no further checking may be needed. In another example, survey may be limited to billing invoices that satisfy a criterion (e.g., that exceed a threshold payment volume).

In some embodiments, the GUI 700 includes a display option 704 for viewing a surveillance report 706. The surveillance report may identify a merchant ID 708 of the customer that is surveyed, and results of the survey 710. The results of the survey may indicate whether the pricing data for the merchant is anomalous (“Yes”) or not (“No”).

In some embodiments, the systems and methods for detecting billing anomalies discussed above, is implemented in one or more processors. The term processor may refer to one or more processors and/or one or more processing cores. The one or more processors may be hosted in a single device or distributed over multiple devices (e.g. over a cloud system). A processor may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processor, as used herein, each function is performed either by hardware configured, i.e., hard-wired, to perform that function, or by more general-purpose hardware, such as a CPU, configured to execute instructions stored in a non-transitory storage medium (e.g. memory). A processor may be fabricated on a single printed circuit board (PCB) or distributed over several interconnected PCBs. A processor may contain other processing circuits; for example, a processing circuit may include two processing circuits, an FPGA and a CPU, interconnected on a PCB.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

The terminology used herein is for the purpose of describing particular embodiments only and is not intended to be limiting of the inventive concept. Also, unless explicitly stated, the embodiments described herein are not mutually exclusive. Aspects of the embodiments described herein may be combined in some implementations.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

Although exemplary embodiments of systems and methods for detecting billing anomalies have been specifically described and illustrated herein, many modifications and variations will be apparent to those skilled in the art. Accordingly, it is to be understood that systems and methods for detecting billing anomalies constructed according to principles of this disclosure may be embodied other than as specifically described herein. The disclosure is also defined in the following claims, and equivalents thereof.

What is claimed is:

1. A method comprising:
identifying data generated for a customer;
identifying a first set of features associated with the customer based on the data;
performing an anomaly evaluation based on detecting a criterion, wherein the anomaly evaluation comprises:
automatically identifying a customer segment based on the first set of features;
identifying a distribution of values for the customer segment;
determining, based on the distribution of values, whether a value associated with the first set of features satisfies a threshold; and
in response to the determining that the value satisfies the threshold, invoking a machine learning model for predicting an anomaly for the customer based on at least a portion of the data; and
transmitting a notification about the anomaly, wherein the notification triggers an action for addressing the anomaly.

2. The method of claim 1, wherein the anomaly includes an error in pricing data for the customer, wherein the pricing data is used for computing an invoice amount for the customer.

3. The method of claim 1, wherein the first set of features include at least one of total transactions, total payment value, total revenue, or type of fee rate.

4. The method of claim 1, wherein the customer segment is one of a plurality of customer segments, wherein a set of the plurality of customer segments is automatically identified based on an algorithm.

5. The method of claim 1, wherein the threshold is computed based on an interquartile range of the distribution of values.

6. The method of claim 1, wherein the distribution of values is associated with a pricing parameter for computing an invoice amount.

7. The method of claim 6, wherein the pricing parameter is stored as an unstructured pricing parameter, and the identifying the distribution of values for the customer segment includes:
converting the unstructured pricing parameter into a structured pricing parameter, wherein the identifying the distribution of values is based on the structured pricing parameter.

8. The method of claim 1, wherein the machine learning model includes one of an unsupervised machine learning model or a supervised machine learning model.

9. The method of claim 1, wherein the machine learning model includes an unsupervised machine learning model and a supervised machine learning model, wherein the method further comprises:
making an anomaly prediction by the unsupervised machine learning model; and
training the supervised machine learning model based on the anomaly prediction.

10. The method of claim 9, wherein the training includes:
detecting validation of the anomaly prediction;
generating a label based on the validation;
associating the label to at least a portion of the data for generating labeled data; and
including the labeled data to a training dataset.

11. A system comprising:
a processor; and
a memory, wherein the memory stores instructions that, when executed by the processor, cause the processor to:
identify data generated for a customer;
identify a first set of features associated with the customer based on the data;
identify a customer segment based on the first set of features;
identify a distribution of values for the customer segment;
determine, based on the distribution of values, whether a value associated with the first set of features satisfies a threshold; and
in response to instructions that cause the processor to determine that the value satisfies the threshold, invoke a machine learning model for predicting an anomaly for the customer; and
transmit a notification about the anomaly.

12. The system of claim 11, wherein the anomaly includes an error in pricing data for the customer, wherein the pricing data is used for computing an invoice amount for the customer.

13. The system of claim 11, wherein the customer segment is one of a plurality of customer segments, wherein a number of the plurality of customer segments is automatically identified based on an algorithm.

14. The system of claim 11, wherein the distribution of values is associated with a pricing parameter for computing an invoice amount.

15. The system of claim 14, wherein the pricing parameter is stored as an unstructured pricing parameter, and the instructions that cause the processor to identify the distribution of values for the customer segment include instructions that cause the processor to:
convert the unstructured pricing parameter into a structured pricing parameter, wherein the instructions that cause the processor to identify the distribution of values include instructions that cause the processor to identify the distribution of values based on the structured pricing parameter.

16. A non-transitory computer readable medium storing instructions that, when executed by a processor, cause the processor to:
identify data generated for a customer;
identify a first set of features associated with the customer based on the data;
identify a customer segment based on the first set of features;
identify a distribution of values for the customer segment;
determine, based on the distribution of values, whether a value associated with the first set of features satisfies a threshold; and
in response to instructions that cause the processor to determine that the value satisfies the threshold, invoke a machine learning model for predicting an anomaly for the customer; and
transmit a notification about the anomaly.

17. The non-transitory computer readable medium claim 16, wherein the anomaly includes an error in pricing data for the customer, wherein the pricing data is used for computing an invoice amount for the customer.

18. The non-transitory computer readable medium claim 16, wherein the customer segment is one of a plurality of customer segments, wherein a number of the plurality of customer segments is automatically identified based on an algorithm.

19. The non-transitory computer readable medium claim 16, wherein the distribution of values is associated with a pricing parameter for computing an invoice amount.

20. The non-transitory computer readable medium claim 19, wherein the pricing parameter is stored as an unstructured pricing parameter, and the instructions that cause the processor to identify the distribution of values for the customer segment include instructions that cause the processor to:
convert the unstructured pricing parameter into a structured pricing parameter, wherein the instructions that cause the processor to identify the distribution of values include instructions that cause the processor to identify the distribution of values based on the structured pricing parameter.
